(19) United States
(12) Patent Application Publication
(10) Pub. No.: US 2008/0112774 A1
(43) Pub. Date: May 15, 2008

(54) Adjusting Device For Rotating And Tilting Bolts

(76) Inventor: Dieter Ramsauer, Schwelm (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/592,616

(22) PCT Filed: Mar. 3, 2005
(86) PCT No.: PCT/EP05/02224

§ 371 Date: Oct. 12, 2007

(30) Foreign Application Priority Data
Mar. 10, 2004 (DE) 20 2004 003 708.4

(51) Int. Cl. F16B 35/02

(52) U.S. Cl. 411/384

(57) ABSTRACT

The description relates to an adjusting device for hook spindle rotating bolts, sash fastener rotating bolts, pull-turn bolts, swiveling bolts and the like of closures, particularly of closures for mounting in thin walls, such as sheet-metal cabinets with a frame (62) and door (12), in which the closures (10) have a closure driveshaft (24) which is provided with an external thread (22) and which holds a bolt (26) so as to be axially adjustable, and/or a bolt which is provided with an internal thread or bore hole near its free end and which holds a back-engaging device (34) so as to be adjustable perpendicular to the back-engagement plane (36). According to the invention, the rotating bolt (26) carries or forms an internal thread (38) for screwing in the closure driveshaft (24) and one side of a coupling (40), such as a claw coupling, which acts by positive engagement, whose other side (42) is held by the closure driveshaft (24) so as to be rigid against rotation.

### BACKGROUND OF THE INVENTION

The invention is directed to an adjusting device for rotating and swiveling bolts. In particular, the invention relates to an adjusting device for hook spindle rotating bolts, sash fastener rotating bolts, pull-turn bolts, and swiveling bolts of closures, particularly of closures for mounting in thin walls, such as sheet-metal cabinets with a frame and door, in which the closures have a closure driveshaft which is provided with an external thread and which holds a bolt so as to be axially adjustable, and/or a bolt which is provided with an internal thread or bore hole near its free end and which holds a back-engaging device so as to be adjustable perpendicular to the back-engagement plane.

### PRIOR ART

WO 0170629A1 discloses a sash fastener rotating bolt closure which can be installed in a thin wall with the clamp device. The closure has a driveshaft which is provided with an external thread and at which a bolt is held by two lock nuts so as to be axially adjustable. For adjustment, it is necessary to loosen the two lock nuts, move the bolt into the desired position, and then tighten the lock nuts again. This is very complicated.

WO 00/31365 discloses a rotating bolt closure with a pull device in which the bolt is provided at its free end with an internal thread in which a rear-engagement device formed as a screw is held so as to be adjustable perpendicular to the back-engagement plane. Adjustment is again ensured by a lock nut. Also, adjustment is again complicated because a lock nut must be loosened, then the back-engaging device must be moved to the appropriate distance by turning, and then the lock nut must be tightened again.

WO 007/73605 shows a swivel lever closure in the drawing accompanying the Abstract. The swivel lever itself forms the back-engaging device. There is no possibility provided for adjustment.

### OBJECT OF THE INVENTION

It is the object of the invention to provide an adjusting device of the type mentioned above which can either be adjusted very simply and quickly or which does not require an adjustment at all.

### MODES FOR CARRYING OUT THE INVENTION

The above-stated object is met according to a first embodiment form in that the rotating bolt carries or forms an internal thread for screwing in the closure driveshaft and one side of a coupling such as a claw coupling which acts by positive engagement, whose other side is held by the closure driveshaft so as to be rigid against rotation.

According to another, related solution, the back-engaging device has an external thread for screwing into the thread of the free end of the bolt and a locking member which acts by frictional engagement, such as a lock nut, or a spring which forces the back-engaging device on the back-engagement surface in the closed position of the closure. In the former case, the adjustment can be fixed but is somewhat complicated to achieve. In the latter case, an adjustment is not required at all and, on that account, is also not fixed.

According to a third, related embodiment form, the driveshaft is provided with a noncircular cross section and has, e.g., an axially extending groove or flattened portion, and the rotating bolt has an opening which fits this cross section, and holding devices are provided which force the rotating bolt outward, and a stop device, for example, in a form of a nut which can be screwed onto the driveshaft, which holds the rotating bolt axially. Insofar as the driveshaft has a noncircular cross section and the portion of the claw coupling that is rigid against rotation with respect to the driveshaft has an opening which fits this cross section, it would be advantageous according to a further development of the invention to provide holding devices which press the coupling parts or coupling sides together. In particular, these holding devices can be formed by a spiral spring which is slid onto the shaft. The coupling part which contacts the spring can advisably have a projecting rim or grip collar to simplify handling.

However, the holding devices can also be a nut such as a knurled nut which is screwed onto the shaft.

The actuation shaft which is noncircular in cross section advisably has at least one axially extending flattened portion and this flattened portion advisably carries an adjusting graduation to facilitate handling and, in particular, to implement preadjustable distances.

Alternatively, the back-engaging device can be a head pin which is displaceable in the bolt against spring force. No adjustment at all is required; rather, the spring device provides for adapting in each instance to the distance between the door leaf on the one side and the back-engagement surface of the door frame on the other side.

To limit the movement of the pin due to spring force, it may be advantageous to provide a retaining ring device in the base of the pin.

In the present embodiment form, the coupling disk has four claws or projections/recesses arranged at intervals of ninety degrees. The opening of the locking disk and the cross section of the shaft can be shaped in such a way, for example, with four chords or flattened portions, that four positions which are offset by 90 degrees are formed between the locking disk on one side and the shaft on the other side, so that 90-degree locking is possible.

### BRIEF DESCRIPTION OF THE DRAWINGS

The invention will now be explained more fully with reference to embodiment examples shown in the drawings.

FIGS. 1A and 1B show a side view and a rear view of a pull-turn bolt with quick adjustment of the rotating bolt distance from the thin wall holding the closure;

FIGS. 2A and 2B show a side view and a bottom view of the rotating bolt used in FIG. 1;

FIGS. 3A and 3B show a side view and a top view of an adjusting ring with four catch positions;

FIGS. 4A and 4B show a side view and a cross-sectional view of a driveshaft which is provided with a slot and which also carries a graduation;

FIG. 5 shows a partial view of FIG. 1A to illustrate the pushed in state (closed position) of the closure;

FIG. 6 shows a side view of a swivel lever with adjusting device which is designed according to the invention;

FIG. 7A shows a side view of a quick adjustment of the distance of the frame from the door leaf provided in a hook spindle closure;

FIG. 7B shows a partial view of another embodiment form of the arrangement according to FIG. 7A;

FIGS. 8A, 8B and 8C show three views in a more detailed illustration of the hook spindle shown in FIG. 7A;

FIG. 9A shows a shape of the driveshaft that is suitable for the closures shown above;

FIG. 9B shows a side view through the shaft to illustrate the four flattened portions selected in this case which are spaced apart by 90 degrees;

FIGS. 10A and 10B show a side view and a top view of the locking disk used in FIG. 9A;

FIGS. 11A and 11B show a view of the lock opening with a non-linear cross section and the head of a hook spindle lock which is arranged in the lock opening;

FIGS. 12A and 12B show a rotating bolt closure in which the tongue can be adjusted by a helix screw against spring force with respect to its height or its distance for mounting in the wall;

FIG. 12C shows a top view of the tongue; and

FIG. 12D shows an axial sectional view through the tongue.

### DETAILED DESCRIPTION OF THE INVENTION

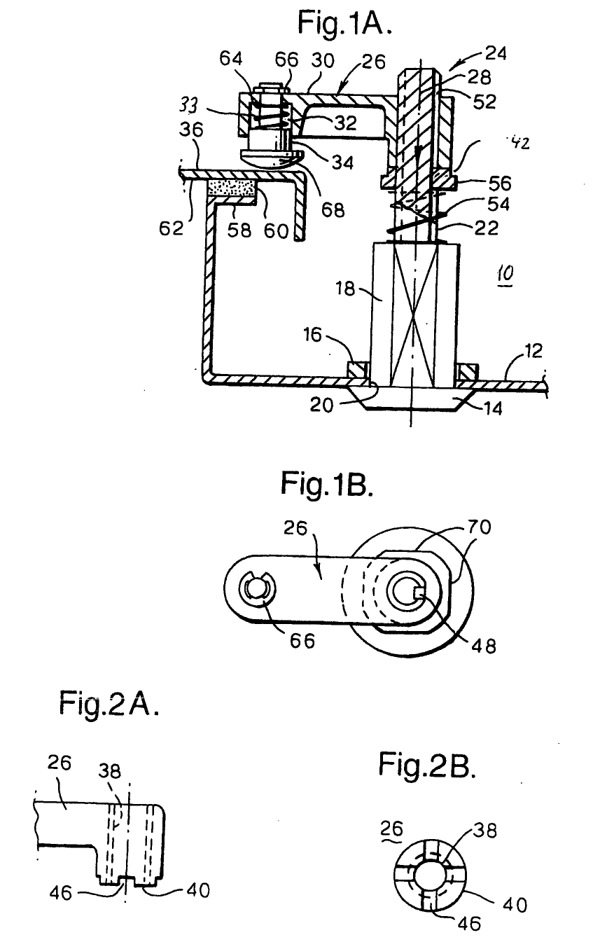

FIG. 1 A shows a pull-turn bolt closure 10 which is held in an opening 20 in a thin wall such as a door leaf 12 by its housing 18 which has a flange 14 and a coupling nut 16. The housing 18 holds a closure driveshaft 24 provided with an external thread 22 so as to be rotatable and displaceable to a limited extent. A bolt 26 is held on this closure driveshaft 24 so as to be adjustable in direction of the shaft axis 28. The bolt 26 shown here has, at its free end 30, a bore hole 32 with a back-engaging device 34 which is constructed as a pin and which is adjustable perpendicular to the back-engagement plane 36.

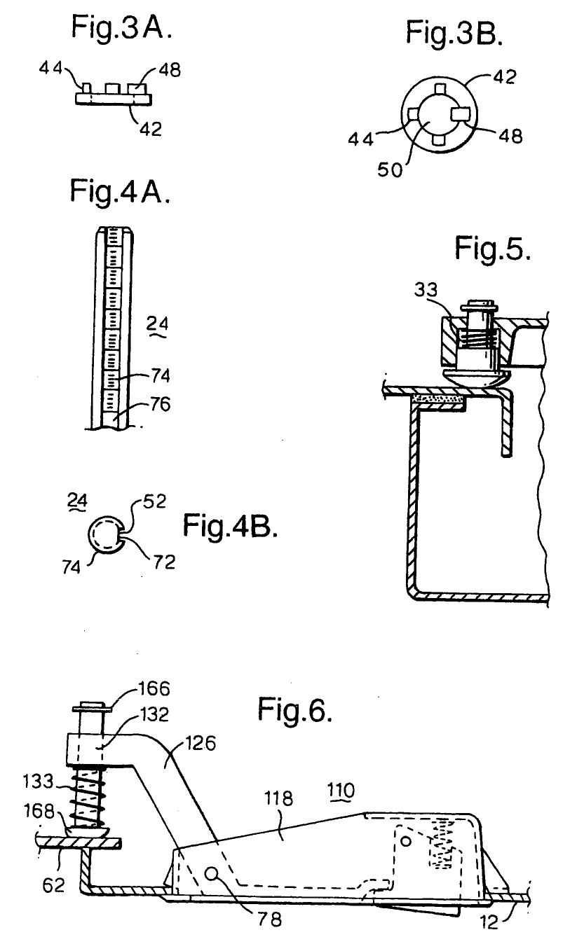

As is shown in FIG. 2A in a side view of a part of the rotating bolt 26, this rotating bolt 26 has an internal thread 38 for screwing in the closure driveshaft 24 by its thread 22. The bottom end of the thread according to FIG. 2A passes into a coupling side 40 which acts by positive engagement, while the other side of this coupling, which presents a claw coupling, forms a coupling disk 42 which is shown from the side in FIG. 3A and from the top in FIG. 3B. The coupling disk or locking disk 42 has projections or claws 44 which are arranged at a distance of 90 degrees relative to one another and which can engage in correspondingly arranged recesses 46 at the front surface or coupling side 40 of the bolt 26. The bolt 26 can therefore be locked in with respect to the disk 42 in steps of 90 degrees. The coupling disk 42 has a bore hole 50 which allows the closure driveshaft 24, including its thread, to project through, but wherein one of the projections 44 extends into the passage of this bore hole 50 (see reference number 48) so as to cooperate with an axial slot or groove 62 which is formed on the closure driveshaft 24. In this way, the locking disk 42 is axially displaceable but not rotatable with respect to the driveshaft 24. Therefore, when the coupling disk 42 is pushed against the coupling side 40 of the bolt 26, the latter is held in the position shown here, and a spring 54 which is supported on the end of the housing 18 presses the disk 42 in this blocking function as can be seen in FIG. 1A. The coupling disk 42 forms a collar 56 so that it can be engaged by hand more easily and pushed downward against the force of the spring 54 to carry out an adjustment of the pull-turn bolt. While the disk 42 is held by the hand so as to be disengaged, the rotating bolt 26 can be turned around the driveshaft 24 and, accordingly, the distance of the back-engaging device 34 from the back-engagement surface 36 can be changed by means of the thread. When the proper adjustment is achieved, the locking disk 42 is released and engages again in the front side 40 of the rotating bolt 26, in which position the rotating bolt 26 is held so as to be rigid against rotation with respect to the shaft 24.

The adjustment is carried out in such a way that, with the pull-turn bolt 26 tightened, a door leaf 12 is pressed with its edge 58, possibly having a seal 60, e.g., against a frame 62 until the seal 60 closes. This state is shown in FIG. 5. The spring-loaded pin 34 enables a desired edge compensation and a self-adjusting compression of the seal 60. The spring 32 is supported on the head shoulder area of the pin 34 on one side and on a shoulder 64 formed by the bore hole 32 on the other side. The retaining ring 66 at the end of the pin 34 prevents the pin from falling out of the rotating bolt 26. The construction shown in FIGS. 1A and 1B accordingly enables a pre-adjustment by means of the thread 38 of the bolt 26 and a fine adjustment of height compensation by the displaceable arrangement of the back-engaging device 34 formed by the pin 34. It will be noted that the head of the pin is rounded, see reference number 68, so that it can also stop on the back-engagement area 36 in the partially tightened state.

The housing 18 has flattened portions 70 (preferably four pieces at intervals of 90 degrees) which cooperate with corresponding narrowed portions in the opening 20 of the door leaf 12 and accordingly enable mounting at intervals of 90 degrees so as to be rigid against rotation.

The groove 52 has a base, which base surface 72 can be used for arranging a graduation (see FIGS. 4A, 4B) which makes it possible to pre-adjust the bolt 26 on the shaft 24 prior to mounting in a cabinet.

When the driveshaft 24 is likewise provided with a flattened portion 74, it is possible to arrange another graduation 74 with better visibility than that arranged in the base 72 of the groove.

The special feature of the spring-loaded pin is also used in a swiveling bolt according to FIG. 6 which is not otherwise adjustable. The swivel bolt closure 110 shown in FIG. 6 comprises a housing 118 which can be snapped into an opening in a door leaf 12, A swivel bolt 126 which is swivelable around an axis, see 78, is arranged in the housing 118. The free end of the swivel bolt 126 also carries a bore hole 132 in which a head pin 168 is supported so as to be displaceable against the force of a pressure spring 133, wherein a lock washer 166 limits the thrust path.

The spring-loaded pin also results in a compensation of tolerances in case of imprecise manufacture and when sealing measures are undertaken.

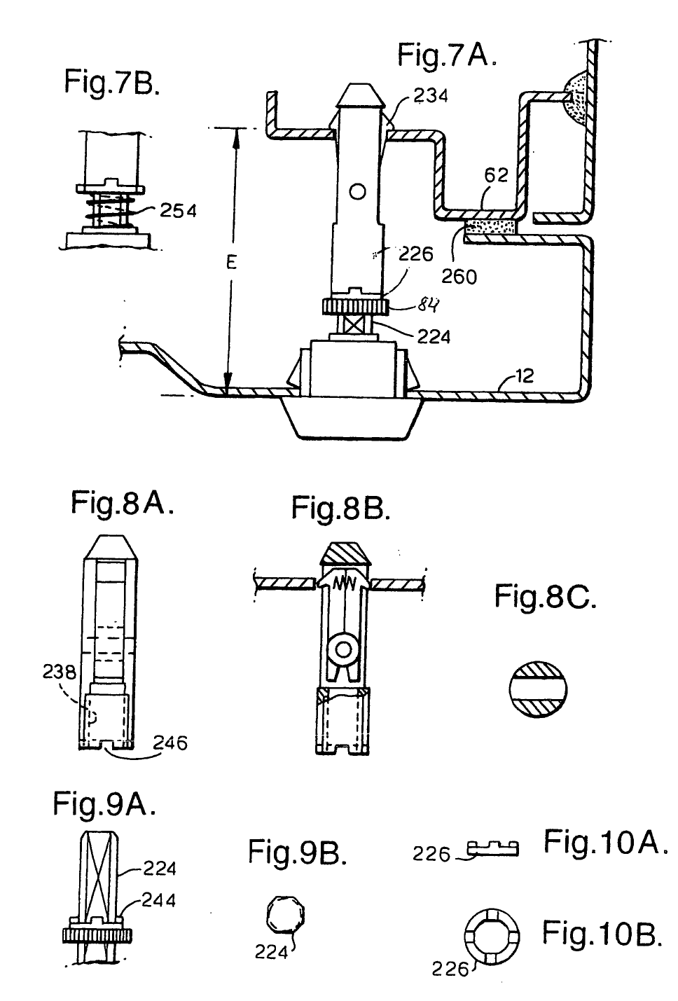

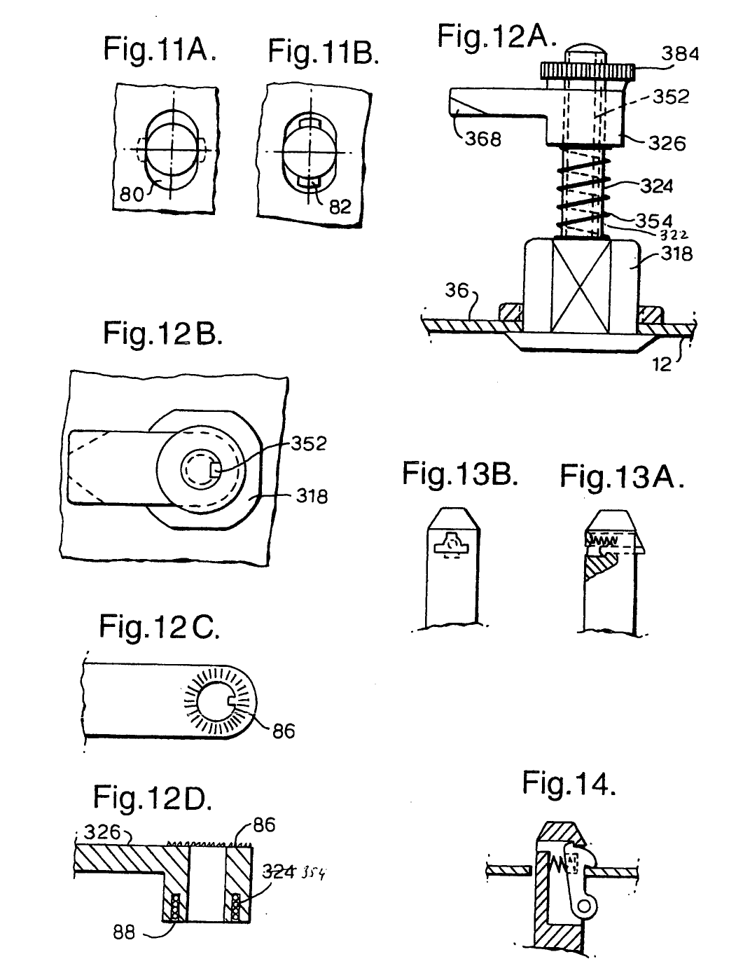

FIG. 7A shows the application of the fixing device according to the invention in a closure with a hook spindle device. A housing which is snapped into the door leaf 12 supports a shaft 224 on which the base of a hook spindle locking part 226 is arranged. The spindle penetrates a bore hole or lock opening 80 (see FIGS. 11A and 11B) in the frame 62. In one position of the spindle (FIG. 11B), the hook 82 can pass through the opening 80, but in a position that is rotated by 90 degrees (FIG. 11A) it cannot. Accordingly, FIG. 11A shows the closed position and FIG. 11B shows the open position. Also, to compensate for tolerances required, for example, as a result of the seal 260, the hook spindle with its internal thread 238 can be screwed onto and off of the shaft 224 which is provided with an external thread so that the back-engagement surface of the hook 234 can be adapted more exactly with respect to the surface of the door leaf. A locking disk 244 can again be used to block the spindle in a certain position subsequently. This locking disk 244 is held either by a spring 254, according to FIG. 7B, or by a knurled nut 84, according to FIG. 7A, which can be screwed onto the thread of the driveshaft 224. Instead of a groove, the driveshaft 224 in this case has a noncircular outer cross section to which the inner cross section of the locking disk 226 is adapted so that the locking disk 226 can be slid axially back and forth on the shaft 224 but cannot rotate.

The hook 82 can extend outward rigidly or, in order to facilitate closing when the driveshaft is not in the closing position, can be constructed flexibly, e.g., by means of levers which retract into the spindle against spring force according to FIGS. 8A, 8B and 8C, by means of slide arrangements which are flexible against spring force according to FIGS. 13A and 13B, and by means of a spindle which has a fulcrum for a level according to FIG. 14.

In the embodiment form shown in FIGS. 12A and 12B, a closure housing is held in a door leaf 12 by means of coupling nuts in a manner similar to that shown in FIG. 14A. Flattened portions prevent rotation in the opening in the thin wall 12. The housing 318 supports a driveshaft 324 on which a tongue 236 without a thread can slide axially but is fixed with respect to rotation, e.g., by means of a groove 352 in which a corresponding projection of the rotating bolt 326 engages. A pressure spring 354 which is supported at the housing 318 and which encircles the shaft 324 presses the tongue 326 against a knurled nut 384 which cooperates with a thread on the shaft 324 and accordingly makes it possible to adjust the distance of the back-engagement surface 368 of the tongue from the door leaf plane 36.

The tongue 326 can have a toothing 86 according to FIGS. 12C, 12D which engages with a corresponding toothing of the knurled nut 384 for locking.

Further, according to FIG. 12D, the tongue can have a cylindrical groove 88 for receiving the compressed spring 324.

### COMMERCIAL APPLICABILITY

The invention is commercially applicable in switch cabinet construction.

### REFERENCE NUMBERS

10, 110 pull-turn bolt closure
12 thin wall, door leaf
14 flange
16 coupling nut
18, 318 housing
20 opening
22, 322 external thread
24; 224, 324 closure driveshaft
26, 126, 226, 326 bolt; hook spindle locking part; tongue; locking disk
28 shaft axis
30 free end
32, 132 bore hole
33, 133 spring; back-engaging device
34, 234 bolt, hook; back-engaging device
36 back-engagement plane
38, 239 internal thread
40 coupling side
42 coupling disk, locking disk
44 projection, claw
46 recess
48 projection
50 bore hole, opening
52, 254 groove
54, 224, 354 (spiral) spring, holding devices
56 collar
58 edge
60, 260 seal
62 frame
64 shoulder
66, 168 retaining disk
68, 168, 368 back-engaging device, rounded stop
70 flattened portions
72 flattened portions, base
74 graduation, flattened portion
76 flattened portion
78 axis
80 bore hole
82 hook
84, 384 stop devices, nut, knurled nut
86 toothed surface (of the bolt)
88 cylindrical groove

1. Adjusting device for rotating bolts such as hook spindle rotating bolts, sash fastener rotating bolts, pull-turn bolts of closures, particularly of closures for mounting in thin walls, such as a door leaf (12) and door frame (62), wherein the closures (10) have a closure driveshaft (24) which is provided with an external thread (22) and which holds a bolt (26) so as to be axially adjustable, and/or a bolt (26) which is provided with an internal thread (38) or bore hole near its free end (30) and which holds a back-engaging device (34) so as to be adjustable perpendicular to the back-engagement plane (36), characterized in that the rotating bolt (26) carries or forms an internal thread (38) for screwing in the closure driveshaft (24) and one side of a coupling such as a claw coupling, which acts by positive engagement, whose other side is held by the closure driveshaft (24) so as to be rigid against rotation.

2. Adjusting device for sash fastener rotating bolts and pull-turn bolts of closures, particularly of closures for mounting in thin walls, such as sheet-metal cabinets with a frame (64) and a door (12), wherein the closures have a closure driveshaft (324) which is provided with an external thread (322) and which holds a bolt (326) so as to be axially adjustable, and/or a bolt (26) which is provided with an internal thread or bore hole near its free end and which holds a back-engaging device (34) so as to be adjustable perpendicular to the back-engagement plane, characterized in that the driveshaft (324) has a noncircular cross section, e.g., an axially extending groove (352) or flattened portion, and the bolt (326) has an opening which fits this cross section, and in that holding devices (354) are provided which force the bolt outward and stop devices (384) which hold the bolt (326) axially, such as a nut (384) which can be screwed onto the driveshaft (324).

3. Adjusting device for rotating bolts or swiveling bolts, in particular of closures for mounting in thin walls, such as sheet-metal cabinets with a frame and door, wherein the closure has a closure driveshaft, which is provided with an external thread and which holds a bolt so as to be axially adjustable, and/or a bolt (126) which is provided with an internal thread or bore hole (132) near its free end and which holds a back-engaging device (168, 133) so as to be adjustable perpendicular to the back-engagement plane, characterized in that the back-engaging device has either an external thread for screwing into the thread of the free end of the bolt and a locking member which acts by frictional engagement such as a lock nut or a spring (133) which forces the back-engaging device (168, 133, 166) on the back-engagement surface (62) in the closed position of the closure (110) in direction of the back-engagement surface (62).

4. Adjusting device according to claim 1, characterized in that the driveshaft (24) has a noncircular cross section, e.g., an axially extending groove or flattened portion (52, 74), and the portion (42) of the claw coupling that is rigid against rotation with respect to the driveshaft has an opening (50) which fits this cross section, and in that holding devices (54) are provided which press the coupling parts (42, 40) or coupling sides together.

5. Adjusting device according to claim 4, characterized in that the holding devices are formed by a spiral spring (54) which is slid onto the shaft (24).

6. Adjusting device according to claim 5, characterized in that the coupling part (42) which contacts the spring (54) has a projecting rim or grip collar (56).

7. Adjusting device according to claim 4, characterized in that the holding devices are formed by a nut such as a knurled nut (84) which is screwed onto the shaft.

8. Adjusting device according to one of claims 4 to 7, characterized in that the actuation shaft (24) which is noncircular in cross section has at least one axially extending flattened portion (70, 72), and in that this flattened portion carries an adjusting graduation (74).

9. Adjusting device according to one of claims 4 to 7, characterized in that the back-engaging device is a head pin (34) which is displaceable in the bolt (26) against spring force (33).

10. Adjusting device according to claim 9, characterized in that the base of the pin carries a retaining ring (66, 166) which limits the movement of the pin due to spring force (33, 133).

11. Adjusting device according to one of claims 4 to 10, characterized in that the coupling disk or locking disk (42) has four claws or projections/recesses arranged at intervals of ninety degrees.

12. Adjusting device according to claim 11, characterized in that the opening of the locking disk (226) of the shaft is shaped in such a way, for example, with four chords or flattened portions, that four positions which are offset by 90 degrees are formed between the locking disk (226) and the shaft (224) so that a 90-degree locking is possible.

13. Adjusting device according to claim 2 or 7, characterized in that the bolt (326) has a toothed surface (86) which engages with a corresponding toothing of the nut (384) so as to lock the latter.

14. Adjusting device according to one of claims 2, 4 or 5, characterized in that the bolt (326) has a cylindrical groove (88) for receiving the compressed spring (354).
